(19) United States
(12) Patent Application Publication
(10) Pub. No.: US 2008/0299334 A1
(43) Pub. Date: Dec. 4, 2008

(54) Thermal transfer receiving sheet

(75) Inventors: Chikara Tsukada, Yokohama-shi (JP); Masanori Ohashi, Tokyo (JP); Toru Nakai, Soka-shi (JP); Kazuyuki Tachibana, Tokyo (JP); Noriyuki Fujii, Tokyo (JP); Mitsuru Tsunoda, Tokyo (JP); Naoki Kubo, Mihama-ku (JP)

Correspondence Address: KRATZ, QUINTOS & HANSON, LLP, 1420 K Street, N.W., Suite 400, WASHINGTON, DC, 20005, US

(73) Assignee: OJI PAPER CO., LTD., Tokyo (JP)

(21) Appl. No.: 12/155,432

(22) Filed: Jun. 4, 2008

(30) Foreign Application Priority Data
Jun. 4, 2007 (JP) 2007-147698

(51) Int. Cl. B41M 5/40

(52) U.S. Cl. 428/32.69

(57) ABSTRACT

A thermal transfer receiving sheet in which at least a low-density layer, barrier layer and image receiving layer are sequentially laminated on one side of a sheet-like support, wherein the low-density layer contains hollow particles, a hydrophobic resin adhesive and a hydrophilic resin adhesive, the hydrophobic resin adhesive is at least one type selected from the group consisting of acrylic acid ester-acrylonitrile copolymer, methacrylic acid ester-acrylonitrile copolymer, styrene-butadiene copolymer, butadiene-acrylonitrile copolymer, styrene-butadiene-acrylonitrile copolymer and polybutadiene, the glass transition temperature in accordance with JIS K 7121 is between −90 and 10° C., and the weight ratio between the hydrophobic resin adhesive and the hydrophilic resin adhesive is between 95/5 and 65/35.

### TECHNICAL FIELD

The present invention relates to a thermal transfer receiving sheet (to be simply referred to as a receiving sheet) used in a printer for forming images by thermal transfer of a colorant to a thermal transfer sheet by superimposing with the thermal transfer sheet and using a thermal head for the device. More particularly, the present invention relates to a low-cost receiving sheet suitable for thermal printers, and particularly dye thermal transfer printers, that allows the obtaining of images having high density similar to that of silver halide photographs as well as superior image uniformity.

### BACKGROUND ART

Thermal printers, and particularly dye transfer thermal printers have attracted attention in recent years for allowing the obtaining of prints of vivid, full-color images. Dye thermal transfer printers form images by superimposing a dye layer containing a dye of a thermal transfer sheet (to be simply referred to as an ink ribbon) and an image receiving layer containing a dyeable resin of a receiving sheet (to be simply referred to as a receiving layer), and transferring a predetermined concentration of dye at a predetermined location of the dye layer to the receiving layer using heat supplied from a thermal head and the like. The ink ribbon has a dye layer containing the three colors of yellow, magenta and cyan, or four colors consisting of these three colors plus black. Full-color images are obtained by repeatedly transferring dye of each color of the ink ribbon to the receiving sheet in order.

The image quality and the like of recorded images has improved remarkably, and the market for thermal transfer systems has grown, due to the advancement of computerized digital image processing technology. In addition, accompanying improvement of temperature control technology for thermal heads, there is a growing demand for higher speeds and greater sensitivity of printing systems. Consequently, the extent to which the amount of heat generated by thermal heads and other heating devices can be efficiently used for image formation is becoming an important technical topic.

Receiving sheets are typically composed of a sheet-like support and a receiving layer formed on the surface thereof, and examples of conventionally used sheet-like supports include various types of film base materials, paper base materials and laminated base materials thereof.

For example, as a surface layer base material provided with both smoothness and cushioning, a film-laminated support and the like has been disclosed that comprises a porous base material obtained by forming a molten resin composition comprising various types of pigments and incompatible components in a thermoplastic resin into a sheet and then expanding it to form voids, wherein the base material is laminated with a core layer such as paper and the like (see, for example, Japanese Unexamined Patent Publication No. S61-197282 (page 1) and Japanese Unexamined Patent Publication No. S62-198497 (page 1)).

Moreover, a receiving sheet is disclosed provided with a layer having adiabatic properties and cushioning in the form of a low-density layer containing organic hollow particles between a paper support and a receiving layer for the purpose of improving recording sensitivity, image quality and the like (see, for example, Japanese Unexamined Patent Publication No. S63-87286 (pages 1 and 2), Japanese Unexamined Patent Publication No. H1-27996 (pages 1 to 3), Japanese Unexamined Patent Publication No. 2002-200851 (pages 2 to 5), Japanese Unexamined Patent Publication No. 2004-284347 (page 1) and Japanese Unexamined Patent Publication No. 2006-130892 (page 1)). In this receiving sheet, sensitivity is improved due to the effects of improving adiabatic properties and cushioning of the low-density layer attributable to the organic hollow particles. However, since polymer resin typically used for the partitions of the organic hollow particles has a glass transition temperature of about 100° C. resulting in inadequate heat resistance, and since the partitions of the hollow particles are thin, the hollow particles ended up being crushed due to thermal deformation caused by heat present during production of the receiving sheet and heat generated from the thermal head during printing, thereby resulting in the problem of difficulty in controlling density during printing. In addition, there was also the problem of printed areas being indented resulting in impaired appearance due to heat or pressure applied in the case of being contacted with a fingernail and the like.

In order to improve this indentation caused by pressure or heat as described above, although it is possible to reduce indentation by increasing the thickness of the partitions by reducing the hollow ratio of the organic hollow particles, for example, adiabatic properties become insufficient and printing density tends to decrease. Alternatively, although it is possible to reduce indentation without lowering printing density by making the glass transition temperature of the synthetic resin adhesive used to adhere the hollow particles somewhat higher to harden the low-density layer, cushioning of the low-density layer becomes inadequate and image quality tends to decrease. Thus, there are limitations on the degree to which quality balance can be adjusted with such methods.

In addition, although the glass transition temperature is defined for an adhesive resin used in a expandable microcapsule-containing layer, the resin composition is not particularly limited due to the occurrence of different problems, and an adhesive resin like that of the present invention has not been indicated (see, for example, Japanese Unexamined Patent Publication No. H6-270559 (pages 8 and 9)).

Japanese Unexamined Patent Publication No. S61-197282 (page 1)

Japanese Unexamined Patent Publication No. S62-198497 (page 1)

Japanese Unexamined Patent Publication No. S63-87286 (pages 1 and 2)

Japanese Unexamined Patent Publication No. H1-27996 (pages 1 to 3)

Japanese Unexamined Patent Publication No. 2002-200851 (pages 2 to 5)

Japanese Unexamined Patent Publication No. 2004-284347 (page 1)

Japanese Unexamined Patent Publication No. 2006-130892 (page 1)

Japanese Unexamined Patent Publication No. H6-270559 (pages 8 and 9)

### DISCLOSURE OF THE INVENTION

In consideration of the aforementioned circumstances, an object of the present invention is to provide a low-cost thermal transfer receiving sheet that solves the problems of receiving sheets of the prior art as described above, is particularly suitable for dye thermal transfer printers, has high printing density and satisfactory image uniformity, has reduced extent of dents caused by heat or pressure, and has superior overall quality as a receiving sheet.

The present invention includes each of the inventions described above.

(1) A thermal transfer receiving sheet in which at least a low-density layer, a barrier layer and an image receiving layer are sequentially laminated on at least one side of a sheet-like substrate; wherein, the low-density layer contains hollow particles, a hydrophobic resin adhesive and a hydrophilic resin adhesive, the hydrophobic resin adhesive is at least one type selected from the group consisting of acrylic acid ester-acrylonitrile copolymer, methacrylic acid ester-acrylonitrile copolymer, styrene-butadiene copolymer, butadiene-acrylonitrile copolymer, styrene-butadiene-acrylonitrile copolymer and polybutadiene, the glass transition temperature in accordance with JIS K 7121 is between −90 and 10° C., and the weight ratio between the hydrophobic resin adhesive and the hydrophilic resin adhesive is between 95/5 and 65/35.
(2) The thermal transfer receiving sheet described in (1) above, wherein the DHT hardness of the hydrophobic resin adhesive is 1.0 or less, and the return rate defined as “load release depth”/maximum load depth”×100(%) during measurement of the DHT hardness is 40% or more.
(3) The thermal transfer receiving sheet described in (1) or (2) above, wherein the ratio of the total weight of the hydrophobic resin adhesive and the hydrophilic resin adhesive in accordance with the total solid content weight of the low-density layer is between 25 and 80% by weight.
(4) The thermal transfer receiving sheet described in any of (1) to (3) above, wherein the volumetric hollow rate of the hollow particles is between 45 and 97%.

The receiving sheet of the present invention is a thermal transfer receiving sheet that allows the obtaining of high-density images having superior image uniformity using a thermal transfer printer, while also having reduced extent of dents caused by heat or pressure.

Although the receiving sheet of the present invention is composed of a low-density layer, a barrier layer and an image receiving layer sequentially laminated on at least one side of a sheet-like substrate, the receiving sheet of the present invention can naturally be given improved performance by further providing other layers as necessary. The following provides a detailed explanation of these layers.

(Low-Density Layer)

In the present invention, a low-density layer, at least having hollow particles and a hydrophilic resin adhesive for adhering the hollow particles, is provided on a sheet-like support. The providing of this low-density layer makes it possible to impart adiabatic properties and cushioning to the receiving sheet.

In the present invention, the hydrophobic resin adhesive used when forming the low-density layer is required to be at least one type selected from the group consisting of acrylic acid ester-acrylonitrile copolymer, methacrylic acid ester-acrylonitrile copolymer, styrene-butadiene copolymer, butadiene-acrylonitrile copolymer, styrene-butadiene-acrylonitrile copolymer and polybutadiene, or a resin mixture of two or more types thereof. As a result of containing a structure unit such as acrylonitrile or butadiene in the monomer composition of the hydrophobic resin adhesive, elasticity can be imparted to the resulting hydrophobic resin adhesive, thereby enabling the receiving sheet to return to its original form due to the elasticity of the hydrophobic resin adhesive even if indented by heat or pressure, and making it possible to reduce indentation caused by heat or pressure.

In addition, the glass transition temperature of the hydrophobic resin adhesive is required to be −90 to 10° C., preferably −90 to 5° C., more preferably −90 to 0° C. and particularly preferably −90 to −15° C. If the glass transition temperature of the hydrophobic resin adhesive exceeds 10° C., the low-density layer formed becomes hard, while cushioning simultaneously worsens, thereby resulting in exacerbation of image quality due to the occurrence of pinholes and the like during printing. On the other hand, if the glass transition temperature is lower than −90° C., the hydrophobic resin adhesive has difficulty in obtaining adequate effects as an adhesive in room temperature environments in which it is typically used, while also making it difficult to be acquired in the form of a commercially available product.

Furthermore, the glass transition temperature of the hydrophobic resin adhesive used in the present invention is the value measured using a differential scanning calorimeter (trade name: SSC5200, Seiko Epson Corp.) in accordance with the method defined in JIS K 7121.

In addition, it is important that the hydrophilic resin adhesive also be incorporated at a specific ratio when forming the low-density layer. The hydrophilic adhesive serves as a crosslink that connects the hollow particles and hydrophobic adhesive, and since the hydrophobic resin adhesive and hollow particles are adhered through the hydrophilic resin adhesive, indented hollow particles are able to return to their original form due to the elastic force of the hydrophobic resin adhesive even if the hollow particles are crushed by pressure and the like. In other words, defects caused by crushing of the hollow particles can be eliminated, and more specifically, defects including pinholes during printing caused by indentations in the surface of the receiving sheet, decreased printing density caused by decreased adiabatic properties, and worsening of the appearance of images due to indentations formed resulting from a fingernail and the like contacting a printed receiving sheet can be eliminated. These effects can be demonstrated by making the weight ratio between the hydrophobic resin adhesive and the hydrophobic resin adhesive 95/5 to 65/35, and more preferably 90/10 to 70/30.

If the weight ratio of the hydrophilic resin adhesive is less than 5 parts by weight, the effect of adhering the hollow particles and hydrophobic resin adhesive is lost, thereby making it difficult for indented hollow particles to return to their original form. On the other hand, if the weight ratio of the hydrophilic resin adhesive exceeds 35 parts by weight, the hydrophilic resin adhesive impairs the elastic force of the hydrophobic resin adhesive, thereby decreasing the effect of enabling indented hollow particles to return to their original form. Furthermore, water-soluble resins having hydroxyl groups or carboxyl groups are used for the hydrophobic resin adhesive.

Specific examples of water-soluble resins that can be used include starch, modified starch, hydroxyethyl cellulose, methyl cellulose, carboxymethyl cellulose, gelatin, casein, gum Arabic, fully saponified polyvinyl alcohol, partially saponified polyvinyl alcohol, various types of denatured polyvinyl alcohol, ethylene-vinyl alcohol copolymer, isobutylene-maleic anhydride copolymer salt, styrene-maleic anhydride copolymer salt, styrene-acrylic acid copolymer salt, ethylene-acrylic acid copolymer salt, urea resin, urethane resin, melamine resin and amide resin. Particularly preferable examples include partially saponified polyvinyl alcohol, denatured polyvinyl alcohol, ethylene-vinyl alcohol, styrene-maleic acid copolymer salt and styrene-acrylic acid copolymer salt.

In the present invention, DHT hardness of the hydrophobic resin adhesive used when forming the low-density layer is preferably 1.0 or less, and the return rate when measuring DHT hardness is preferably 40% or more. In general, the hardness of a thin film can be determined from the distortion when a static load is applied perpendicular to the material surface. The DHT hardness and return rate of the hydrophobic resin adhesive in the present invention are determined using the methods described below.

Measuring instrument: DUH-W201 Dynamic Ultra Micro Hardness Tester (Shimadzu Corp.)

Depressor used: 115° triangular pyramidal depressor

Measuring environment: 23° C., 50% RH

Sample production: Hydrophobic resin adhesive is applied to a polyethylene terephthalate film sheet and dried to prepare a resin layer sample having a thickness of 10 μm or more.

Measuring Procedure:
(1) A maximum load of 2 mN is applied at a pressurization rate of 2 mN/sec.
(2) The maximum load is maintained for 5 seconds after the maximum load has been reached.
(3) The “maximum load depth” (h₁) is measured.
(4) The load is released at a depressurization rate of 2 mN/sec.
(5) The “load release depth” (h₂) is measured.

Calculation Procedure:

DHT hardness=K×P/h₁²

Return rate=h₂/h₁

K: Coefficient characteristic to depressor used

P: Maximum load (mN)

h₁: Maximum load depth (μm)

h₂: Release load depth (μm)

The DHT hardness of the hydrophobic resin adhesive is preferably 1.0 or less, more preferably 0.7 or less, and most preferably 0.05 to 0.5. If the DHT hardness exceeds 1.0, the low-density layer formed becomes hard while cushioning simultaneously becomes poor. Thus, image quality may become poor due to the occurrence of portions containing pinholes during printing.

On the other hand, if the DHT hardness is excessively low, for example less than 0.05, the receiving sheet is easily indented and the elastic force of the hydrophobic resin adhesive decreases, thereby diminishing the effect of returning the indentation to its original form.

In addition, the return rate of the hydrophobic resin adhesive when measuring DHT hardness as described above is preferably 40% or more, more preferably 45% or more and most preferably 50% or more. Furthermore, the upper limit of the return rate is 100%. If the return rate is less than 40%, the thermal transfer receiving sheet is easily indented by heat or pressure.

In the present invention, the ratio of the total weight of the hydrophobic resin adhesive and hydrophilic resin adhesive based on the total solid content weight of the low-density layer is preferably 25 to 80% by weight, more preferably 30 to 80% by weight and most preferably 35 to 75% by weight. Furthermore, if this ratio is less than 25% by weight, coated film strength decreases and the coated film separates or cracks form therein. On the other hand, if the above weight ratio exceeds 80% by weight, since this means that there is a shortage of hollow particles, adequate adiabatic properties are unable to be obtained, thereby resulting in a decrease in density of printed images and a decrease in image quality.

The expandable hollow particles used in the low-density layer of the present invention are microcapsulated expandable hollow particles having, for example, a low boiling point hydrocarbon such as n-butane, i-butane, pentane or neopentane for the core, and a homopolymer resin consisting of a monomer such as acrylonitrile, methacrylonitrile, methyl methacrylate, styrene, vinylidene chloride or vinyl chloride, or a copolymer resin thereof, for the wall (shell).

In addition, the microcapsular hollow particles used in the low-density layer of the present invention are obtained by a microcapsule-forming polymerization, in which microcapsules using a polymer material (shell-forming material) for the wall (shell) and containing a volatile liquid (pore-forming material) for the core are dried followed by evaporative escape of the pore-forming material to form a hollow core. Hard resins such as styrene-(meth)acrylic acid ester-based copolymers and melamine resin are preferably used for the polymer-forming material, while water, for example, is used for the volatile liquid.

The volumetric hollow rate of the hollow particles used in the low-density layer of the present invention is preferably 45 to 97%, more preferably 50 to 95% and most preferably 55 to 90%. If the volumetric hollow rate of the hollow particles is less than 45%, the adiabatic properties of the resulting low-density layer is inadequate, thereby preventing the obtaining of sufficient density. In addition, if the volumetric hollow rate exceeds 97%, since the shell thickness of the hollow particles becomes excessively thin, the hollow particles are already susceptible to crushing during formation of the low-density layer, or problems occur due to decreased adiabatic properties and the like. If the hollow particles are already crushed during formation of the low-density layer, the effect of the synthetic resin adhesives cannot be demonstrated. Furthermore, the volumetric hollow rate of the hollow particles can be determined from the volumetric specific gravity of a dispersion of the hollow particles, the solid content concentration and the true specific gravity of the resin that composes the hollow particles.

The average particle diameter of the hollow particles used in the present invention following formation of the low-density layer is preferably between 0.3 and 20 μm and more preferably between 0.5 and 18 μm. In the case of using expandable hollow particles, for example, although either a method in which the low-density layer is formed by preparing and coating a coating solution for the low-density layer comprising pre-expanded particles, or a method in which the low-density layer is formed by preparing and coating a coating solution for the low-density layer comprising non-expanded particles, followed by expanding the particles by heating, may be used, in terms of the uniformity and flatness of the surface of the resulting low-density layer, a method in which the low-density layer is formed by preparing and coating a coating solution for the low-density layer comprising pre-foamed particles is more preferable. If the average particle diameter of the hollow particles following expansion in the low-density layer exceeds 20 μm, the smoothness of the surface of the low-density layer decreases resulting in poor image quality. In addition, if the average particle diameter of the hollow particles after expansion is less than 0.3 μm, adequate adiabatic properties are unable to be obtained, thereby causing a decrease in printing density.

Furthermore, the average particle diameter of the hollow particles of the present invention refers to the value measured using, for example, a laser diffraction-type particle size distribution measuring instrument (trade name: SALD2000, Shimadzu Corp., median diameter of 50% volumetric distribution). In addition, the average particle diameter of the hollow particles can also be determined from observations of photomicrographs of cross-sections of the hollow particles obtained with a scanning electron microscope (SEM) or transmission electron microscope (TEM).

A heat-induced change in the volumetric hollow rate of the hollow particles of the present invention, defined as the difference between the volumetric hollow rate obtained by measuring non-heat-treated hollow particles at 25° C. and the volumetric hollow rate obtained by measuring hollow particles at 25° C. subjected to heat treatment for 10 minutes in an environment at a temperature of 120° C. followed by cooling on standing, is preferably 10% or less, more preferably 6% or less and particularly preferably 4% or less.

If the heat-induced change in the volumetric hollow rate as described above exceeds 10%, the heat resistance of the hollow particles becomes inadequate, and deformation and destruction of the hollow particles occurs due to heat used in the drying process during production of the receiving sheet, thereby preventing the obtaining of desired smoothness and adiabatic properties while also impairing the appearance of the receiving sheet. In addition, the hollow particles may be destroyed or deformed due to heat applied from the thermal head during printing of the receiving sheet, thereby causing indentations in the resulting image, impairing image quality and decreasing printing density.

In addition, examples of materials that can be used to compose the low-density layer include various inorganic and organic pigments, waxes and metallic soaps, and various types of additives such as ultraviolet absorbers, fluorescent dyes, oil repellent agents or viscosity adjusters can further be used as necessary within a range that does not impair the desired effects.

The coating amount as the solid content of the low-density layer is preferably between 1 and 50 g/m² and more preferably between 5 and 25 g/m². If the coating amount as the solid content of the low-density layer is less than 1 g/m², adequate adiabatic properties and cushioning are inadequate, density may decrease or image quality may become poor. In addition, if the coating amount as the solid content exceeds 50 g/m², adiabatic properties and cushioning effects become saturated, thereby resulting in problems such as not being economically preferable.

The receiving sheet of the present invention can be provided with an undercoating layer between the support and the low-density layer for the purpose of, for example, preventing penetration of the low-density layer coating into the support when forming the low-density layer as necessary.

(Sheet-Like Support)

Paper composed mainly of cellulose pulp, for example, is used for the sheet-like support used in the receiving sheet of the present invention. The paper used preferably has low thermal contraction, satisfactory adiabatic properties, satisfactory aesthetic properties as a receiving paper, and is inexpensively priced. Paper to which pressure has been applied with a calendar roll and the like for increasing smoothness followed by compression to improve surface smoothness is particularly preferable. In addition, the paper may also have a coating layer coated with a pigment as necessary. Specific examples of such paper include non-coated paper such as wood-free paper or neutral paper, coated paper, art paper, coated paper such as cast coated paper, synthetic resin-impregnated paper and cardboard.

Additional examples of the sheet-like support include oriented films mainly composed of polyolefins such as polyethylene, polypropylene, polyesters such as polyethylene terephthalate, polyamides, polyvinyl chloride or polystyrene, various types of synthetic resin films mainly composed of polyolefins or polyester resins, porous oriented films (such as synthetic paper) having a single layer or multilayer structure, in which a molten mixture, incorporating resins incompatible with these resins and inorganic pigments, is extruded from an extruding machine followed by expansion to form voids, and laminates thereof. Moreover, a compound sheet in which these synthetic resin films and the paper described above are laminated using a known adhesive can also be used, and in such compound sheets, the aforementioned low-density layer is preferably provided on the paper side.

Among these sheet-like supports, those containing paper are used particularly preferably in terms of adiabatic properties, aesthetic properties as a receiving paper, price and the like. In addition, a sheet-like support of the present invention may employ a configuration of a compound laminate, in which a first base layer, in which the receiving layer is formed, an adhesive layer, a release agent layer and a second base layer are laminated in that order, and a support having a so-called sticker or seal type of structure can naturally also be used.

The sheet-like support used in the present invention preferably has a thickness of 50 to 300 Mm. Incidentally, if the thickness is less than 50 μm, the mechanical strength of the sheet-like support becomes inadequate, the rigidity of the receiving sheet obtained therefrom decreases, resistance to deformation becomes inadequate, and curling of the receiving sheet during printing cannot be adequately prevented. In addition, if the thickness exceeds 300 μm, since the resulting receiving sheet is excessively thick, this leads to a decrease in the number of receiving sheets able to be housed in the printer, or leads to an increase in the volume of the printer in an attempt to house a predetermined number of receiving sheets, resulting in problems such as difficulting in achieving compact size for the printer.

(Barrier Layer)

In the present invention, a barrier layer is preferably provided between the low-density layer and the image receiving layer. Since an organic solvent such as toluene or methyl ethyl ketone is typically used for the solvent of the receiving layer coating solution, the barrier layer is effective as a barrier for forming the receiving layer at a predetermined thickness and for preventing bleeding of images. The barrier layer of the present invention can be formed to be comparatively thin by coating a resin-containing coating solution followed by drying, and the effect of improving the adiabatic properties of the low-density layer can be demonstrated more efficiently. In addition, in comparison with the case of using a molten resin for the barrier layer, the amount of heat applied to the low-density layer is less, which is more preferably since the amount of damage to which the formed low-density layer is subjected can be reduced.

A resin having superior film formation ability, prevents penetration of organic solvent and has elasticity and flexibility is used for the resin used in the barrier layer. Specific examples of resins used in the form of an aqueous solution include water-soluble resins (water-soluble polymer resins) such as starch, modified starch, hydroxyethyl cellulose, methyl cellulose, carboxymethyl cellulose, gelatin, casein, gum Arabic, fully saponified polyvinyl alcohol, partially saponified polyvinyl alcohol, silanol-modified polyvinyl alcohol, carboxy-modified polyvinyl alcohol, acetoacetyl group-modified polyvinyl alcohol, ethylene-vinyl alcohol copolymer, isobutylene-maleic anhydride copolymer salt, styrene-maleic anhydride copolymer salt, styrene-acrylic acid copolymer salt, ethylene-acrylic acid copolymer salt, urea resin, urethane resin, melamine resin or amide resin.

In addition, water-dispersible resins can also be used, examples of which include styrene-butadiene copolymer latex, acrylic acid ester resin-based latex, methacrylic acid ester-based copolymer resin latex, ethylene-vinyl acetate copolymer latex, polyester polyurethane ionomer and polyether-polyurethane ionomer.

Among the aforementioned resins, water-soluble resins are used preferably. In addition, the aforementioned resins may be used alone or two or more types may be used in combination.

Moreover, various types of pigment may be contained in the barrier layer, and a swellable inorganic layered compound is used preferably, use thereof not only prevents penetration of coating solvent, but also allows the obtaining of superior effects in terms of preventing bleeding of thermal transfer dyeable images. Specific examples of swellable inorganic layered compounds include graphite, phosphate-based derivative compounds (such as zirconium phosphate-based compounds), calogen compounds, hydrotalcite compounds, lithium aluminum compound hydroxides and clay-based minerals (such as synthetic micas, synthetic smectites, smectites, vermiculites and micas).

These swellable inorganic layered compounds may be naturally-occurring (clay-based minerals), synthetic or processed (for example, products surface-treated with a silane coupling agent), and more preferable examples of synthetic swellable inorganic layered compounds include synthetic micas such as fluorophlogopite, potassium tetrasilicic mica, sodium tetrasilicic mica, sodium taeniolite or lithium taeniolite, and synthetic smectites such as sodium hectorite, lithium hectorite or saponite. Among these, sodium tetrasilicic mica is particularly preferable, and that having a desired particle diameter, aspect ratio and crystallinity are obtained by fusion synthesis.

The aspect ratio of the swellable inorganic layered compound is preferably within the range of 5 to 5,000 and more preferably within the range of 100 to 5,000. If the aspect ratio is less than 5, image bleeding may occur, while if the aspect ratio exceeds 5,000, image uniformity becomes inferior. The aspect ratio (Z) is expressed by the relationship of Z=L/a, wherein L represents the particle average major axis in water of the swellable inorganic layered compound (measured by, for example, using a laser diffraction-type particle size distribution measuring instrument, trade name: SALD2000, Shimadzu Corp., median diameter of 50% volumetric distribution), while a represents the thickness of the swellable inorganic layered compound.

The thickness a of the swellable inorganic layered compound is the value determined from observations of photomicrographs of cross-sections of the barrier layer obtained by a scanning electron microscope (SEM) or transmission electron microscope (TEM). The particle average major axis of the swellable inorganic layered compound is preferably within the range of 0.1 to 100 μm and more preferably within the range of 0.3 to 50 μm. If the particle average major axis is less than 0.1 μm, in addition to decreasing the aspect ratio, it becomes difficult to lay the barrier layer level on the low-density layer, which may prevent image bleeding from being completely prevented. If the particle average major axis exceeds 100 μm, the swellable inorganic layered compound ends up protruding from the barrier layer, causing the occurrence of surface irregularities in the surface of the barrier layer and decreasing the smoothness of the receiving layer surface, thereby resulting in poor image quality.

In addition, a white inorganic pigment or fluorescent dye such as calcium carbonate, titanium dioxide, zinc oxide, aluminum hydroxide, barium sulfate, silicon dioxide, aluminum oxide, talc, kaolin, diatomaceous earth or satin white may be contained in the form of an inorganic pigment in the barrier layer to impart opacity and whiteness and improve the texture of the receiving sheet.

The coating amount as the solid content of the barrier layer is preferably within the range of 0.1 to 8 g/m 2 and more preferably 0.5 to 5 g/cm 2 Incidentally, if the coating amount as the solid content of the barrier layer is less than 0.1 g/m², the barrier layer is unable to completely cover the surface of the low-density layer, and the effect of preventing penetration of the solvent of the receiving layer coating solution in the form of an organic solvent becomes inadequate. On the other hand, if the coating amount as the solid content of the barrier layer exceeds 8 g/m 2, coating effects become saturated, which in addition to being uneconomical, prevents adiabatic and cushioning effects from being adequately demonstrated due to excessive thickness of the barrier layer, thereby leading to a decrease in image density.

(Receiving Layer)

The receiving layer is provided either on the aforementioned low-density layer or barrier layer in the receiving sheet of the present invention. The receiving sheet itself may be a known dye thermal transfer receiving layer. A resin having high affinity for dye migrating from an ink ribbon, and thus a resin having satisfactory dyeability, is used for the resin that forms the receiving layer. Examples of such dyeable resins include polyester resin, polycarbonate resin, polyvinyl chloride resin, vinyl chloride-vinyl acetate copolymer resin, polyvinyl acetal resin, polyvinyl butyral resin, polystyrene resin, polyacrylic acid ester resin, cellulose derivative-based resins such as cellulose acetate butyrate, thermoplastic resins such as polyamide resin, and active energy beam-curable resins. These resins preferably have a functional group having reactivity with a crosslinking agent used (for example, functional groups such as an amino group, carboxyl group or epoxy group).

In addition, one or more types of additives such as a crosslinking agent, release agent or lubricant is preferably incorporated in the receiving layer to prevent fusion between the receiving layer and ink ribbon due to heat from the thermal head during printing. Moreover, one or more types of fluorescent dyes, plasticizers, antioxidants, pigments, fillers, ultraviolet absorbers, photostabilizers or antistatic agents and the like may be further added to the receiving layer described above as necessary. These additives may be mixed with components that form the receiving layer prior to coating, or they may be coated over and/or under the receiving layer in the form of a separate coating layer.

The receiving layer can be formed by preparing a receiving layer coating solution by suitably dissolving or dispersing the dyeable resin and necessary additives such as a crosslinking agent or release agent in an organic solvent or water, coating the coating solution onto the low-density layer or barrier layer using a known coater, drying the coating layer, and heat-curing as necessary. In addition, the coating solution can also be coated by preparing the dyeable resin and necessary additives such as a crosslinking agent or release agent in the form of a solvent-free receiving layer coating solution and then coating or coating after melting.

The coating amount as the solid component of the receiving layer is preferably within the range of 0.1 to 12 g/m² and more preferably within the range of 1 to 10 g/m². Incidentally, if the coating amount as the solid component of the receiving layer is less than 0.1 g/m², the receiving layer is unable to completely cover the surface of the low-density layer or barrier layer, thereby leading to a decrease in image quality or the occurrence of fusion problems due to the receiving layer and ink ribbon being adhered by the heat from the thermal head. On the other hand, if the coating amount as the solid content of the receiving layer exceeds 12 g/m², coating effects become saturated, which in addition to being uneconomical, results in a lack of receiving layer film strength or excessively thick coated film thickness, thereby preventing the adiabatic effects of the low-density layer from being adequately demonstrated and leading to a decrease in image density.

(Back Base Layer)

The sheet-like support of the present invention may also be provided with a back base layer mainly composed of a thermoplastic resin on the back side of the support (opposite side from the side on which the receiving layer is provided), and a back layer to be described to follow may be further laminated on this back base layer. The providing of this back base layer makes it possible to prevent the occurrence of curling of the resulting receiving sheet, and particularly in the case the sheet-like support is paper, is effective in improving the moisture resistance of the receiving sheet.

Examples of the thermoplastic resin used in the back base layer include various thermoplastic resins such as polyolefin-based resin, polyester-based resin, acrylic resin, vinyl chloride-based resin, vinyl acetate-based resin, cellulose derivative-based resin, vinyl-based resin, polyamide-based resin and polyurethane-based resin. In addition, a white inorganic pigment such as titanium dioxide, calcium carbonate or barium sulfate can be added to the back base layer to improve whiteness of the receiving sheet.

A known film formation method can be used to form the back base layer, and examples of such methods include a method for forming a coating layer by coating and drying a coating solution containing a thermoplastic resin, a method for forming a resin layer by extruding and laminating a thermoplastic resin, and method for laminating various types of synthetic resin films listed in the previously described section on the sheet-like support using a known adhesive. Although there are no particular limitations on the method used, using a laminate of a polyolefin-based resin on a paper base material for the support, using a resin composition mainly composed of a polyolefin-based resin and the like, and then forming the back base layer by molten extrusion and lamination enables the receiving sheet to have a symmetrical structure on the front and back, which is effective in preventing the occurrence of curling.

(Back Layer)

The receiving sheet of the present invention may also be provided with a back layer mainly composed of a polymer resin and organic and/or inorganic filler on the back of the sheet-like support (side on the opposite side from the side on which the receiving layer is provided) or on the back base layer. As a result of providing a back layer, adhesive strength between the back layer and sheet-like support can be improved, printing transportability of the receiving sheet can be improved, damage to the receiving layer side can be prevented, and prevention of transfer of dye to the back layer in contact with the receiving layer side can be improved. Examples of polymer resins that can be used for the back layer include acrylic resin, epoxy resin, polyester resin, phenol resin, alkyd resin, urethane resin, melamine resin, polyvinyl acetal resin and reaction cured products thereof. In addition, the back layer may contain a suitable crosslinking agent such as a polyisocyanate compound or epoxy compound to improve adhesion between the sheet-like support or back base layer and the back layer.

The back layer preferably incorporates a friction coefficient adjuster in the form of an organic or inorganic filler. Examples of organic fillers that can be used include Nylon filler, cellulose filler, urea resin filler, styrene resin filler and acrylic resin filler. Examples of inorganic fillers that can be used include silica, barium sulfate, kaolin, clay, talc, ground calcium carbonate, precipitated calcium carbonate, titanium oxide and zinc oxide.

A conductor such as an electrically conductive polymer or electrically conductive inorganic pigment may be added to the back layer to improve printing transportability and prevent static electricity. Although examples of electrically conductive polymers used include anionic, nonionic and cationic electrically conductive polymers, cationic electrically conductive polymer compounds (such as polyethylene imine, acrylic polymers containing cationic monomers, cationic-modified acrylamide polymer or cationic starch) are used particularly preferably.

The back layer may also contain a fusion preventive agent such as a release agent or lubricant as necessary. Examples of release agents include silicone-based compounds such as non-modified and modified silicone oil, silicone block copolymers or silicone rubber, while examples of lubricants include phosphoric acid ester compounds, fatty acid ester compounds and fluorine compounds. In addition, known antifoaming agents, dispersants, organic pigments, fluorescent dyes, fluorescent pigments and ultraviolet absorbers and the like may also be suitably selected and used.

The coating amount of the back layer as the solid content thereof is preferably within the range of 0.3 to 10 g/m² and more preferably within the range of 1 to 8 g/m². If the coating amount as the solid content is less than 0.3 g m², the ability to prevent damage to the receiving sheet when rubbed is not adequately demonstrated, while also resulting in the risk of the occurrence of defective passage of the receiving sheet. On the other hand, if the coating amount as the solid content exceeds 10 g/m², the effects become saturated thereby making this uneconomical.

In the present invention, the low-density layer, barrier layer, receiving layer, back layer and other coating layers are formed in accordance with ordinary methods, and can be formed by respectively preparing coating solutions containing each required component, applying to the sheet-like support or prescribed coating layer using a known coater such as a bar coater, gravure coater, comma coater, blade coater, air knife coater, gate roll coater, die coater, curtain coater, lip coater or sliding bead coater, and drying.

In the present invention, calendaring may be carried out following formation of each coating layer to further reduce surface irregularities in the surface of the receiving sheet and smoothen the surface. Although there are no particular limitations on the calendaring apparatus, nip pressure, number of nips or surface temperature of the metal roller used, the pressure condition when carrying out calendaring treatment is preferably 0.5 to 150 MPa and more preferably 1 to 100 MPa. Temperature condition is preferably 20 to 150° C. and more preferably 30 to 120° C. A calendaring apparatus ordinarily used in the paper manufacturing industry can be suitably used for the calendaring apparatus, examples of which include a super calendar, soft calendar and gross calendar.

### EXAMPLES

Although the following provides a detailed explanation of the present invention based on the examples indicated below, the scope of the present invention is not limited thereto. Furthermore, in the examples, the terms “%” and “parts” indicate “% by weight” and “parts by weight” of solid components, excluding amounts relating to solvents, unless specifically indicated otherwise.

### Example 1

[Formation of Low-Density Layer]

Art paper having a thickness of 150 μm (trade name: OK Kinfuji N, 174.4 g/m 2, Oji Paper Co., Ltd.) was used for the sheet-like support, and a low-density coating solution 1 having the composition indicated below was coated onto one side thereof to a coating amount as the solid content thereof of 18 g/m² followed by drying to form a low-density layer.

Low-Density Coating Solution 1

| | |
|---|---|
| Expanded hollow particles comprising a copolymer | 45 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 10 parts |
| Kuraray Co., Ltd.) | |
| Polybutadiene resin (trade name: LX111, | 45 parts |
| Tg = −80° C., Zeon Corp.) | |
| Water | 200 parts |

[Formation of Barrier Layer and Receiving Layer]

Next, a barrier layer coating solution having the composition indicated below was coated onto the low-density layer to a coating amount as the solid content thereof of 2 g/m² followed by drying to form a barrier layer, after which a receiving layer coating solution having the composition indicated below was coated onto the barrier layer at a coating amount as the solid content thereof of 5 g/m² followed by drying to form a receiving layer.

Barrier Layer Coating Solution

| | |
|---|---|
| Polyvinyl alcohol (trade name: PVA117, | 70 parts |
| Kuraray Co., Ltd.) | |
| Acrylic resin (trade name: AE-337, | 30 parts |
| JSR Corp.) | |
| Water | 900 parts |

Receiving Layer Coating Solution

| | |
|---|---|
| Polyester resin (trade name: Bylon 200, | 92 parts |
| Toyobo Co., Ltd.) | |
| Silicone oil (trade name: KF393, | 3 parts |
| Shin-Etsu Chemical Co., Ltd.) | |
| Polyisocyanate (trade name: Takenate | 5 parts |
| D-140N, Mitsui Chemicals Polyurethanes, | |
| Inc.) | |
| Toluene/methyl ethyl ketone (1/1) (weight | 400 parts |
| ratio) mixture | |

[Formation of Back Layer]

Next, a back layer coating solution having the composition indicated below was coated onto the side of the sheet-like support opposite from the side on which the low-density layer is provided at a coating amount as the solid content thereof of 5 g/m² followed by drying to form the back layer. This was then aged for 48 hours at 50° C. to obtain a receiving sheet.

Back Layer Coating Solution

| | |
|---|---|
| Polyvinyl acetal resin (trade name: S-LEC | 40 parts |
| KX-1, Sekisui Chemical Co., Ltd.) | |
| Polyacrylic acid ester resin (trade name: | 20 parts |
| Jurymer AT613, Nihon Junyaku Co., Ltd.) | |
| Nylon resin particles (trade name: MW330, | 10 parts |
| Shinto Paint Co., Ltd.) | |
| Zinc stearate (trade name: Z-7-30, | 10 parts |
| Chukyo Yushi Co., Ltd.) | |
| Cationic conductive resin (trade name: | 20 parts |
| Chemistat 9800, Sanyo Chemical Industries, | |
| Ltd. | |
| Water/isopropyl alcohol (2/3) (weight | 400 parts |
| ratio) mixture | |

[Measurement of DHT Hardness and Return Rate]

Polybutadiene latex (LX-111, Zeon Corp.) used for low-density coating solution 1 was coated onto a polyethylene terephthalate film having a thickness of 100 μm to a film thickness after drying of 12 μm followed by drying to form a polybutadiene film. Subsequently, DHT hardness and return rate were measured under measuring conditions consisting of an environment of 23° C. and 50% RH with a 115° triangular pyramidal depressor and load of 2 mN using the DUH-W201 Dynamic Ultra Micro Hardness Tester manufactured by Shimadzu Corp. Furthermore, the DHT hardness of the polybutadiene resin was 0.195 and the return rate was 49.5%.

### Example 2

A receiving sheet was obtained in the same manner as Example 1 with the exception of forming the low-density layer using a low-density layer coating solution 2 having the composition indicated below during the “Formation of Low-Density Layer” of Example 1.

Low-Density Layer Coating Solution 2

| | |
|---|---|
| Expanded hollow particles comprising a copolymer | 45 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 10 parts |
| Kuraray Co., Ltd.) | |
| Styrene-butadiene-acrylonitrile copolymer | 45 parts |
| resin (trade name: LX426, Tg = −39° C., Zeon | |
| Corp.) | |
| Water | 200 parts |

Furthermore, the DHT hardness of the styrene-butadiene-acrylonitrile copolymer resin was 0.290, and the return rate was 48.5%.

### Example 3

A receiving sheet was obtained in the same manner as Example 1 with the exception of forming the low-density layer using a low-density layer coating solution 3 having the composition indicated below during the “Formation of Low-Density Layer” of Example 1.

Low-Density Layer Coating Solution 3

| | |
|---|---|
| Expanded hollow particles comprising a copolymer | 45 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 15 parts |
| Kuraray Co., Ltd.) | |
| Butadiene-acrylonitrile copolymer resin | 35 parts |
| (trade name: LX555, Tg = −35° C., Zeon | |
| Corp.) | |
| Water | 200 parts |

Furthermore, the DHT hardness of the butadiene-acrylonitrile copolymer resin was 0.305, and the return rate was 49.0%.

### Example 4

A receiving sheet was obtained in the same manner as Example 1 with the exception of forming the low-density layer using a low-density layer coating solution 4 having the composition indicated below during the “Formation of Low-Density Layer” of Example 1.

Low-Density Layer Coating Solution 4

| | |
|---|---|
| Expanded hollow particles comprising a copolymer | 45 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 5 parts |
| Kuraray Co., Ltd.) | |
| Acrylic acid ester-acrylonitrile copolymer | 25 parts |
| resin (trade name: Vinybran 2622, Tg = −26° C., | |
| Nisshin Chemical Co., Ltd.) | |
| Water | 200 parts |

Furthermore, the DHT hardness of the acrylic acid ester-acrylonitrile copolymer resin was 0.224, and the return rate was 46.4%.

### Example 5

A receiving sheet was obtained in the same manner as Example 1 with the exception of forming the low-density layer using a low-density layer coating solution 5 having the composition indicated below during the “Formation of Low-Density Layer” of Example 1.

Low-Density Layer Coating Solution 5

| | |
|---|---|
| Expanded hollow particles comprising a copolymer | 40 parts |
| mainly composed of acrylonitrile and | |
| methacrylonitrile (average particle | |
| diameter: 3.2 μm, volumetric hollow | |
| rate: 85%) | |
| Styrene-acrylic acid copolymer (trade | 5 parts |
| name: Polymaron 326, Arakawa Chemical | |
| Industries, Ltd.) | |
| Polybutadiene resin (trade name: LX111, | 55 parts |
| Tg = −80° C., Zeon Corp.) | |
| Water | 200 parts |

### Example 6

A receiving sheet was obtained in the same manner as Example 1 with the exception of forming the low-density layer using a low-density layer coating solution 6 having the composition indicated below during the “Formation of Low-Density Layer” of Example 1.

Low-Density Layer Coating Solution 6

| | |
|---|---|
| Expanded hollow particles comprising a copolymer | 25 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 5 parts |
| Kuraray Co., Ltd.) | |
| Butadiene-acrylonitrile copolymer resin | 70 parts |
| (trade name: 1571H, Tg = −8° C., Zeon Corp.) | |
| Water | 200 parts |

Furthermore, the DHT hardness of the butadiene-acrylonitrile copolymer resin was 0.419, and the return rate was 46.0%.

### Example 7

A receiving sheet was obtained in the same manner as Example 1 with the exception of forming the low-density layer using a low-density layer coating solution 7 having the composition indicated below during the “Formation of Low-Density Layer” of Example 1.

Low-Density Layer Coating Solution 7

| | |
|---|---|
| Expanded hollow particles comprising a copolymer | 45 parts |
| mainly composed of acrylonitrile and | |
| methacrylonitrile (average particle | |
| diameter: 2.8 μm, volumetric hollow | |
| rate: 55%) | |
| Polyvinyl alcohol (trade name: PVA205, | 10 parts |
| Kuraray Co., Ltd.) | |
| Polybutadiene resin (trade name: LX111, | 45 parts |
| Tg = −80° C., Zeon Corp.) | |
| Water | 200 parts |

### Comparative Example 1

A receiving sheet was obtained in the same manner as Example 1 with the exception of forming the low-density layer using a low-density layer coating solution 8 having the composition indicated below during the “Formation of Low-Density Layer” of Example 1.

Low-Density Layer Coating Solution 8

| | |
|---|---|
| Expanded hollow particles comprising a copolymer | 45 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 10 parts |
| Kuraray Co., Ltd.) | |
| Styrene-butadiene-acrylonitrile copolymer | 45 parts |
| resin (trade name: LX1577, Tg = 26° C., Zeon | |
| Corp.) | |
| Water | 200 parts |

Furthermore, the DHT hardness of the styrene-butadiene-acrylonitrile copolymer resin was 1.311, and the return rate was 11.3%.

### Comparative Example 2

A receiving sheet was obtained in the same manner as Example 1 with the exception of forming the low-density layer using a low-density layer coating solution 9 having the composition indicated below during the “Formation of Low-Density Layer” of Example 1.

Low-Density Layer Coating Solution 9

| | |
|---|---|
| Expanded hollow particles comprising a copolymer | 45 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 10 parts |
| Kuraray Co., Ltd.) | |
| Vinyl acetate copolymer resin (trade name: | 45 parts |
| AW919, Tg = 30° C., Chuorika Co., Ltd.) | |
| Water | 200 parts |

Furthermore, the DHT hardness of the vinyl acetate copolymer resin was 9.705, and the return rate was 35.1%.

### Comparative Example 3

A receiving sheet was obtained in the same manner as Example 1 with the exception of forming the low-density layer using a low-density layer coating solution 10 having the composition indicated below during the “Formation of Low-Density Layer” of Example 1.

Low-Density Layer Coating Solution 10

| | |
|---|---|
| Expanded hollow particles comprising a copolymer | 45 parts |
| mainly composed of acrylonitrile and | |
| methacrylonitrile (average particle | |
| diameter: 3.2 μm, volumetric hollow | |
| rate: 85%) | |
| Polyvinyl alcohol (trade name: PVA205, | 10 parts |
| Kuraray Co., Ltd.) | |
| Acrylic acid ester-styrene copolymer resin | 45 parts |
| (trade name: FK900, Tg = 15° C., Chuorika | |
| Co., Ltd.) | |
| Water | 200 parts |

Furthermore, the DHT hardness of the acrylic acid ester-styrene copolymer resin was 3.509, and the return rate was 19.5%.

Evaluation

The receiving sheets obtained in each of the examples and comparative examples were evaluated according to the methods described below, and the results obtained there from are shown in Table 1.

### (1) Printing Quality (Printing Density, Image Uniformity)

Using a commercially available thermal transfer video printer (trade name: UP-DR100, Sony Corp.) and an ink sheet provided with an ink layer, containing three colors of sublimation dyes consisting of yellow, magenta and cyan along with an adhesive, on a polyester film having a thickness of 6 μm, each color of the ink layer was sequentially contacted with a test receiving sheet followed by controlled heating in a stepwise manner with a thermal head to thermally transfer a prescribed image to the receiving sheet, and then gray scale monochromatic and multicolor images for each color were printed out.

The reflection density of recorded images for each applied energy transferred to the receiving sheet was measured using a Macbeth reflection densitometer (trade name: RD-914, Kollmorgen Corp.). The reflection densities of areas of high gradation equivalent to the 15th step are shown as printing density in Table 1 starting with the lowest applied energy. A printing density of 1.8 or more is considered to be adequately suitable for practical use.

Moreover, the uniformity of recorded images at an area of gradation in which the optical density (black) was equivalent to 0.3 was evaluated visually based on the presence or absence of uneven density and pinholes.

Results evaluated as superior are indicated with “excellent”, those evaluated as good are indicated with “good”, those in which there were slight density unevenness and pinholes are indicated with “fair”, and those in which there were prominent uneven density and pinhole defects are indicated with “poor”. An evaluation of “good” or better is required for practical use.

(2) Indentation During Printing

The level difference between printed areas and non-printed areas of the samples printed in the manner described above was evaluated visually. Samples completely free of any level difference are indicated with “excellent”, those for which only a slight level difference was able to be confirmed are indicated with “good”, those for which a level difference was able to be confirmed are indicated with “fair”, and those for which a definite level difference was able to be confirmed are indicated with “poor”. An evaluation of “good” or better is required for practical use.

(3) Pressure-Induced Indentation

A 50 g load was applied to an SUS ball having a diameter of 2 cm and rolled over the surface of a receiving sheet at 600 mm/min followed by visual evaluation of the degree of indentation of the surface thereof.

Samples in which there was no indentation observed whatsoever were evaluated as “excellent”, those for which hardly any indentation was observed were evaluated as “good”, those for which only little indentation was able to be confirmed were evaluated as “fair”, and those for which definite indentation was able to be confirmed were evaluated as “poor”. An evaluation of “good” or better is required for practical use.

TABLE 1

| | Adhesive resin | | | | | |
|---|---|---|---|---|---|---|
| | properties | | | | Indentation | Pressure- |
| | DHT | Return rate | Printing | Image | during | induced |
| | hardness | (%) | density | uniformity | printing | indentation |
| Example 1 | 0.195 | 49.5 | 1.95 | excellent | good | good |
| Example 2 | 0.290 | 48.5 | 1.99 | good | good | good |
| Example 3 | 0.305 | 49.0 | 1.96 | good | good | good |
| Example 4 | 0.224 | 46.4 | 1.94 | excellent | good | good |
| Example 5 | 0.195 | 49.5 | 1.92 | excellent | excellent | excellent |
| Example 6 | 0.419 | 46.0 | 1.89 | good | excellent | excellent |
| Example 7 | 0.195 | 49.5 | 1.88 | excellent | good | good |
| Comp. | 1.311 | 11.3 | 1.90 | good | poor | poor |
| Ex. 1 | | | | | | |
| Comp. | 9.705 | 35.1 | 1.88 | fair | poor | poor |
| Ex. 2 | | | | | | |
| Comp. | 3.509 | 19.5 | 1.85 | poor | fair | poor |
| Ex. 3 | | | | | | |

The receiving sheet of the present invention is particularly suitable for a dye thermal transfer printer, allows the obtaining of high printing density and satisfactory image uniformity, is free of indentations caused by heat and pressure, and demonstrates superior image quality at low costs, thereby having extremely high practical value.

It will be appreciated by those skilled in the art that while the invention has been described above in connection with particular embodiments and examples, the invention is not necessarily so limited and that numerous other embodiments, examples, uses, modifications and departures from the embodiments, examples and use may be made without departing from the inventive scope of this application.

1. A thermal transfer receiving sheet in which at least a low-density layer, a barrier layer and an image receiving layer are sequentially laminated on at least one side of a sheet-like substrate; wherein, the low-density layer contains hollow particles, a hydrophobic resin adhesive and a hydrophilic resin adhesive, the hydrophobic resin adhesive is at least one type selected from the group consisting of acrylic acid ester-acrylonitrile copolymer, methacrylic acid ester-acrylonitrile copolymer, styrene-butadiene copolymer, butadiene-acrylonitrile copolymer, styrene-butadiene-acrylonitrile copolymer and polybutadiene, the glass transition temperature in accordance with JIS K 7121 is between −90 and 10° C., and the weight ratio between the hydrophobic resin adhesive and the hydrophilic resin adhesive is between 95/5 and 65/35.

2. The thermal transfer receiving sheet according to claim 1, wherein the DHT hardness of the hydrophobic resin adhesive is 1.0 or less, and the return rate defined as “load release depth”/maximum load depth”×100(%) during measurement of the DHT hardness is 40% or more.

3. The thermal transfer receiving sheet according to claim 2, wherein the ratio of the total weight of the hydrophobic resin adhesive and the hydrophilic resin adhesive in accordance with the total solid content weight of the low-density layer is between 25 and 80% by weight.

4. The thermal transfer receiving sheet according to claim 3, wherein the volumetric hollow rate of the hollow particles is between 45 and 97%.

5. The thermal transfer receiving sheet according to claim 1, wherein the ratio of the total weight of the hydrophobic resin adhesive and the hydrophilic resin adhesive in accordance with the total solid content weight of the low-density layer is between 25 and 80% by weight.

6. The thermal transfer receiving sheet according to claim 5, wherein the volumetric hollow rate of the hollow particles is between 45 and 97%.

7. The thermal transfer receiving sheet according to claim 2, wherein the volumetric hollow rate of the hollow particles is between 45 and 97%.

8. The thermal transfer receiving sheet according to claim 1, wherein the volumetric hollow rate of the hollow particles is between 45 and 97%.
